(19) United States
(12) Patent Application Publication
(10) Pub. No.: US 2013/0043246 A1
(43) Pub. Date: Feb. 21, 2013

(54) CONTAINER COVER

(71) Applicant: NIV YAARI, YAVNE (IL)

(72) Inventor: NIV YAARI, YAVNE (IL)

(73) Assignee: S.M.L. SUCCESS LTD, TEL AVIV (IL)

(21) Appl. No.: 13/590,213

(22) Filed: Aug. 21, 2012

Related U.S. Application Data
(60) Provisional application No. 61/525,776, filed on Aug. 21, 2011.

(51) Int. Cl. B65D 51/18; B23P 17/00

(52) U.S. Cl. 220/254.3; 29/434

(57) ABSTRACT

A container cover including a cover body, a dispensing opening formed in the cover body and a cap configured to releasably close the dispensing opening. The cap includes a resilient element which is pivotally mounted on the cover body and configured to release the cap when pressure is applied to the resilient element.

### FIELD OF THE INVENTION

The present invention relates to a container cover, in general and, in particular, to a container cover with an easy opening cap.

### SUMMARY OF THE INVENTION

The present invention relates to a container cover having an easy open cap that can be opened with one hand. There is thus provided, according to the present invention, a container cover including a cover body, a dispensing opening formed in the cover body and a cap configured to releasably close the dispensing opening. The cap includes a resilient element which is pivotally mounted on the cover body and configured to release the cap when pressure is applied to the resilient element.

According to some embodiments of the invention, the resilient element is formed of semi-rigid plastic or of resilient metal.

Further according to some embodiments, the resilient element is pivotally coupled about an axis at its distal end to a pair of pivot mounts formed on the cover body.

Preferably, the cap is configured to snap fit onto the dispensing opening. Alternatively, the dispensing opening may define an upstanding collar, where the cap is configured for releasable engagement of the upstanding collar. According to another embodiment, the cap includes a pair of concentric walls, where the internal concentric wall is configured for sealing engagement with the upstanding collar.

According to other embodiments, the cap is rotatably mounted on the resilient element. According to further embodiments, the cap defines a stopper configured for releasable closing of the dispensing opening.

There is also provided, according to the present invention, a method for forming a container cover, the method including forming a cover body having a dispensing opening, releasably closing the dispensing opening by means of a cap, and pivotally mounting the cap on the cover body by means of a resilient element pivotally mounted on the cover body, the resilient element being configured to release the cap when pressure is applied thereto.

### BRIEF DESCRIPTION OF THE DRAWINGS

The present invention will be further understood and appreciated from the following detailed description taken in conjunction with the drawings in which:

FIG. 1 is a schematic illustration of a container cover constructed and operative in accordance with one embodiment of the present invention, in a closed orientation on a container;

FIG. 2 is a schematic illustration of the container cover according to FIG. 1, in a dispensing orientation;

FIG. 3 is schematic illustration of the container cover according to FIG. 1, in an open orientation; and

FIGS. 4a to 4d illustrate schematically the method of operation of the container cover of FIG. 1, according to one embodiment of the invention;

FIG. 5 is a schematic illustration of a container cover constructed and operative in accordance with an alternative embodiment of the present invention, in a dispensing orientation on a container;

FIG. 6 is a schematic illustration of a container cover constructed and operative in accordance with another embodiment of the present invention, in a dispensing orientation on a container; and

FIG. 7 is a schematic side view illustration of a container cover constructed and operative in accordance with a further embodiment of the present invention, in a closed orientation on a container.

### DETAILED DESCRIPTION OF THE INVENTION

The present invention relates to a container cover for a container for holding a dispensable material. The cover includes a releasable cap, pivotally mounted on the cover by means of a flexible or resilient element, for selectively closing a dispensing opening in the body of the cover. The cap may be configured for a snap fit on the dispensing opening in the cover. The cover is configured for removably mounting on a container in order to hold the material inside the container, when the cover is mounted, and for cleaning and/or filling the container with material, when the cover is removed. Preferably, the cover can be mounted on a container in different positions, wherein the dispensing aperture is disposed adjacent different portions of the container, to permit dispensing of material therefrom. The cover according to the present invention permits the user to dispense material from the container by holding it in one hand and removing the cap for dispensing by pressing on the resilient element with one finger of that same hand, and the resilient element then returns to its original shape.

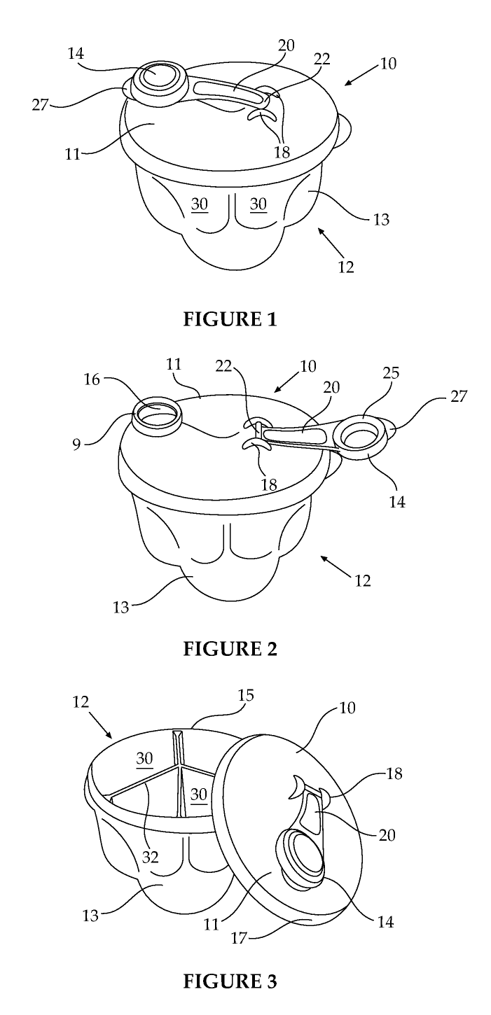

Referring to FIGS. 1 and 2, there are shown schematic illustrations of a container cover 10 constructed and operative in accordance with one embodiment of the present invention, mounted on a multi-compartment container 12, in closed and dispensing orientations, respectively. Container 12 includes a container body 13 for holding at least one dispensable material, for example, a powdered material for mixing with a liquid in a bottle or other fluid container. Cover 10 is configured for removably engaging the top opening of the container for holding the material inside the container, as shown in FIGS. 1 and 2. The cover can be removed from the container, as shown in FIG. 3, in order to clean and/or fill the container body 13. Cover 10 includes a cover body 11. It will be appreciated that cover body 11 can be removably affixed to container body 13 in any conventional manner, for example, by snap fit, complementary screw threads, a bayonet or quick connect arrangement, or in any other fashion. It will be further appreciated that container 12 may preferably include a seal (not shown) which may be mounted on a rim 15 of container body 13 or on the inside wall (not shown) of a rim 17 of cover body 11, in a conventional manner, for providing an air tight seal of the container, in order to prevent dirt and/or moisture from entering the container. Cover 10 further includes a dispensing opening 16 in cover body 11 permitting dispensing of a quantity of material from the container without removing the cover.

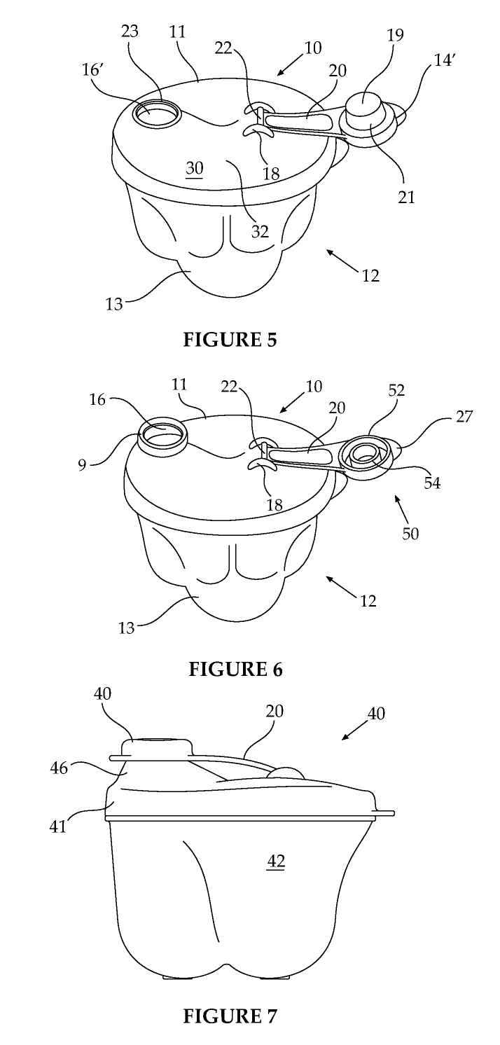

A cap 14 is provided to releasably cover dispensing opening 16 when dispensing is desired. In the illustrated embodiment, cap 14 is a snap fit cap that is pivotally mounted on cover body 11 by means of a resilient element 20 and arranged to releasably close dispensing opening 16 formed in cover 10. Cap 14 preferably includes an inner, annular wall 25, and may include a release tab 27. In the embodiment illustrated in FIG. 2, dispensing opening 16 includes an upstanding collar 9 which is configured for releasable engagement of annular wall 25 of cap 14. According to another embodiment, as shown in FIG. 6, cap 50 may include a pair of concentric walls 52, 54, for receiving collar 9 therebetween. The internal wall is configured to provide a liquid tight sealing engagement with the collar. Alternatively, as shown in FIG. 5, dispensing opening 16′ may have no upstanding collar and the cap 14′ may include a depending stopper 19 having an external wall 21 arranged for engaging the inside wall 23 of the dispensing opening 16′. If desired, stopper 19 may hold a seal (not shown) to sealingly engage the inside wall 23 of the dispensing opening 16′. It will be appreciated that this seal may be integrally formed with stopper 19.

In the illustrated embodiments, cap 14, 14′ is coupled to or integrally formed with a resilient element, here shown as an arcuate mounting strap 20, preferably formed of resilient semi-rigid plastic or resilient, non-corrosive metal, which is pivotally coupled about an axis 22 at its distal end to a pair of pivot mounts 18 formed on the cover body 11. This type of mounting strap 20 provides a spring action, whereby pressing on the strap causes the strap to straighten against the arc, thereby urging cap 14, 14′ away from dispensing opening 16, 16′ and opening the dispensing opening in a quick and easy manner.

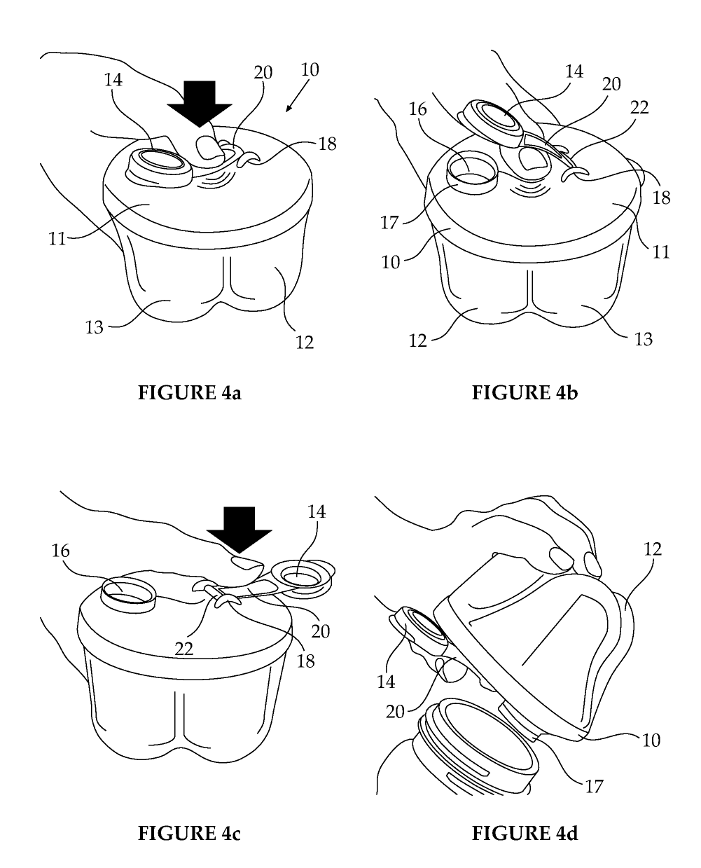

Operation of cap 14 is illustrated in FIGS. 4a to 4d. First, typically in advance of use, body 13 of container 12 is filled with a material to be dispensed and covered with cover 10 for holding the material inside the container body. Cap 14 engages and closes or seals the dispensing opening 16, depending on its construction. When it is desired to dispense some or all of the material, the user holds the container and presses on resilient element 20, as shown in FIG. 4a. This causes cap 14 to disengage from the collar 17 of the dispensing opening, as seen in FIG. 4b, permitting the user to insert his or her thumb underneath the resilient element. The user now can flip the cap about axis 22 to maintain the dispensing opening 16 in the dispensing orientation, as shown in FIG. 4c. Finally, the user can invert the container and dispense the material from the interior through dispensing opening 16, as desired. Here, the container is illustrated as dispensing material from the container into a baby bottle. As can be seen, opening the container and dispensing material inside can be performed with one hand.

According to some embodiments of the invention, as shown, for example, in FIG. 3, the container body defines two or more radially arranged compartments, each adapted to contain the same or a different material to be dispensed. The cover can be mounted on top of the container for selective dispensing from the various compartments. Preferably, the cover body is snap fit onto the container body and can be selectively positioned so that the dispensing opening is located adjacent a selected one of the compartments. Most preferably, the cover can be repositioned, as by rotation, over the various different compartments.

For example, in the embodiment illustrated in FIGS. 1-3, container 12 is a dispenser and is divided into a plurality of radially arranged compartments 30, here illustrated as four compartments, by means of dividing walls 32. Each compartment is arranged to hold one, preferably pre-measured, portion of a material to be dispensed. As can be seen, cover 10 can be rotated and positioned, at any time, such that cap 14 is disposed over any selected compartment.

Referring now to FIG. 7, there is shown a schematic side view illustration of a container cover 40 constructed and operative in accordance with a further embodiment of the present invention, in a closed orientation on a container 42. As can be seen, the dispensing opening (not shown) is formed at the end of a raised, spout-like portion 46. Cap 44 engages the dispensing opening. Resilient element 20 holding cap 44 is pivotally mounted on a portion of the cover 40 which is somewhat raised relative to the cover body 41. A concave “valley” 48 is formed beneath element 20, permitting the user to depress the convex resilient element to a somewhat concave orientation during opening of the cap, thereby providing greater leverage to urge the cap to release the dispensing opening and to open the container.

It will be appreciated that, in any of the described embodiments, the cap may be rotatably mounted on the resilient element. In this case, instead of by a snap fit, the cap may close the dispensing opening by means of a bayonet or quick connect arrangement, a rotational closure, such as complementary screw threads, (not shown) or in any other fashion.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A container cover comprising:
a cover body;
a dispensing opening formed in the cover body;
a cap configured to releasably close said dispensing opening; and
said cap including a resilient element, said resilient element pivotally mounted on the cover body and configured to release said cap when pressure is applied thereto.

2. The cover according to claim 1, wherein said resilient element is formed of semi-rigid plastic.

3. The cover according to claim 1, wherein said resilient element is formed of a resilient metal.

4. The cover according to claim 1, wherein said resilient element is pivotally coupled about an axis at its distal end to a pair of pivot mounts formed on the cover body.

5. The cover according to claim 2, wherein said resilient element is pivotally coupled about an axis at its distal end to a pair of pivot mounts formed on the cover body.

6. The cover according to claim 3, wherein said resilient element is pivotally coupled about an axis at its distal end to a pair of pivot mounts formed on the cover body.

7. The cover according to claim 1, wherein said cap is configured to snap fit on said dispensing opening.

8. The cover according to claim 1, wherein said cap is coupled to said resilient element.

9. The cover according to claim 1, wherein said cap is integrally formed with resilient element.

10. The cover according to claim 1, wherein said dispensing opening defines an upstanding collar, and said cap is configured for releasable engagement of said upstanding collar.

11. The cover according to claim 4, wherein said dispensing opening defines an upstanding collar, and said cap is configured for releasable engagement of said upstanding collar.

12. The cover according to claim 10, wherein said cap includes a pair of concentric walls, said internal concentric wall being configured for sealing engagement with said upstanding collar.

13. The cover according to claim 1, wherein said cap is rotatably mounted on said resilient element.

14. The cover according to claim 1, wherein said cap defines a stopper configured for releasable closing of said dispensing opening.

15. A method for forming a container cover, the method comprising:
forming a cover body having a dispensing opening;
releasably closing said dispensing opening by means of a cap; and
pivotally mounting said cap on the cover body by means of a resilient element pivotally mounted on the cover body and configured to release said cap when pressure is applied thereto.

16. The method according to claim 15, wherein said resilient element is formed of semi-rigid plastic.

17. The method according to claim 15, wherein said resilient element is formed of a resilient metal.

18. The method according to claim 15, wherein said step of pivotally mounting includes pivotally coupling said resilient element about an axis at its distal end to a pair of pivot mounts formed on the cover body.
